(19) United States
(12) Patent Application Publication
(10) Pub. No.: US 2015/0260543 A1
(43) Pub. Date: Sep. 17, 2015

(54) BACKGROUND CALIBRATION

(71) Applicant: INDOORATLAS OY, Oulu (FI)

(72) Inventors: Pekka RANTALANKILA, Oulu (FI); Esa RAHTU, Oulu (FI); Juho KANNALA, Oulu (FI)

(21) Appl. No.: 14/207,916

(22) Filed: Mar. 13, 2014

(51) Int. Cl. G01C 25/00; G01C 21/08

(52) U.S. Cl. CPC G01C 25/00; G01C 21/08

(57) ABSTRACT

There is provided a method, comprising: acquiring results of a set of Earth's magnetic field, EMF, measurements; acquiring motion data indicating the angular rotation that the mobile device experienced during each of a plurality of EMF measurement pairs, wherein each EMF measurement pair indicates a measured first and a second EMF value; determining a bias estimate of the magnetometer on the basis of the plurality of EMF measurement pairs and the corresponding motion data by finding the bias estimate that minimizes distances between the measured second EMF values and the measured first EMF values rotated about the bias estimate by the corresponding angular rotations; and determining a correction factor corresponding to the bias estimate and applying the correction factor to the magnetometer readings.

### FIELD OF THE INVENTION

The invention relates generally to calibration of a sensor as a background process, possibly while a mobile device comprising the sensor, such as a magnetometer or a motion sensor, is moving.

### BACKGROUND

In location discovery and tracking, a technique utilizing Earth magnetic fields (EMF) has been proposed. It is especially suitable in indoor situation where satellite based tracking is not applicable. In such EMF-based tracking, it is important that the values provided by the magnetometer and the motion sensor are reliable.

### BRIEF DESCRIPTION OF THE INVENTION

According to an aspect of the invention, there is provided an apparatus as specified in claim 1.

According to an aspect of the invention, there is provided a method as specified in claim 15.

According to an aspect of the invention, there is provided a computer program product as specified in claim 16.

According to an aspect of the invention, there is provided an apparatus comprising means for performing any of the embodiments as described in the appended claims.

Embodiments of the invention are defined in the dependent claims.

### LIST OF THE DRAWINGS

In the following, the invention will be described in greater detail with reference to the embodiments and the accompanying drawings, in which

FIG. 1 presents an example floor plan of a building;

FIG. 2 shows example magnetometer readings, according to an embodiment;

FIG. 3 shows how location estimation may comprise an error in case bias is present in the input data, according to an embodiment;

FIG. 4 depicts a method, according to an embodiment;

FIGS. 5A to 5E illustrate scenarios for determining the bias of the magnetometer, according to some embodiments;

FIGS. 6A to 6C show how weighting factors may be determined for the calibration process, according to some embodiments;

FIG. 7 illustrates how some EMF measurements pairs may be determined as invalid, according to some embodiments;

FIG. 8 illustrates an embodiment on when the calibration process may be started;

FIG. 9 illustrates an example on how a bias of a motion sensor may be determined and corrected, according to an embodiment; and

FIGS. 10 and 11 illustrate apparatuses according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In order to enable positioning, a GPS based location discovery and/or tracking is known. The GPS location discovery may not, however, be suitable for indoors due to lack of satellite reception coverage. For indoor based location tracking, RF based location discovery and location tracking may be used. In such system, a round trip time of the RF signal, or the power of the received RF signal, for example, may be determined to an indoor base station to which the user device is connected to. Some other known positioning measures, which may be applicable indoors, include machine vision, motion sensor and distance measuring, for example. However, these may require expensive measuring devices and equipment mounted throughout the building. As a further option, the utilization of Earth's magnetic field (EMF) may be applied.

The material used for constructing the building may affect the EMF measurable indoors and also the EMF surrounding the indoor building. For example, steel, reinforced concrete, and electrical systems may affect the EMF. The EMF may vary significantly between different locations in the building and may therefore enable accurate location discovery and tracking inside the building based on the EMF local deviations inside the building. On the other hand, the equipment placed in a certain location in the building may not affect the EMF significantly compared to the effect caused by the building material, etc. Therefore, even if the layout and amount of equipment and/or furniture, etc., change, the measured EMF may not change significantly.

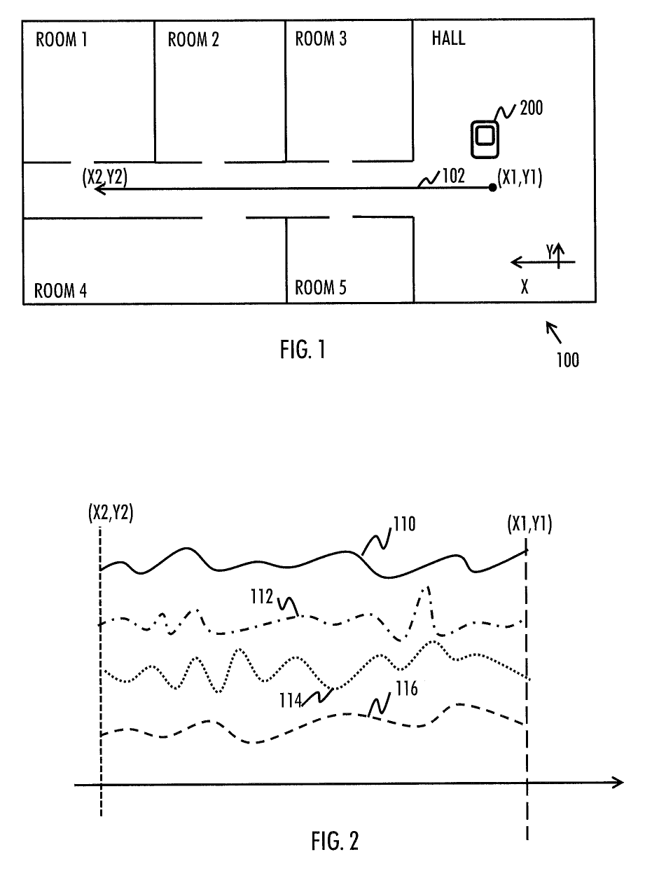

An example of a building 100 with 5 rooms, a corridor and a hall is depicted in FIG. 1. It is to be noted that the embodiments of the invention are also applicable to other type of buildings, including multi-floor buildings. The floor plan of the building 100 may be represented in a certain frame of reference. A frame of reference may refer to a coordinate system or set of axes within which the position, orientation, etc. of a mobile device 200 are measured, for example. Such a frame of reference of the building in the example of FIG. 1 may be an XY coordinate system, also known in this application as the world coordinate system. The coordinate system of the building 100 may also be three-dimensional when vertical dimension needs to be taken into account. The vertical dimension is referred with Z, whereas X and Y together define a horizontal two-dimensional point (X,Y). In FIG. 1, the arrow starting at a point (X1, Y1) and ending at a point (X2, Y2) may be seen as a path 102 traversed by a user associated with the mobile device 200. The vertical Z dimension is omitted for simplicity.

The mobile device 200 is detailed later, but for now it may be said, that the mobile device 200 may comprise a magnetometer or any other sensor capable of measuring the EMF, such as a Hall sensor or a digital compass. The magnetometer may comprise at least one orthogonal measuring axis. However, in an embodiment, the magnetometer may comprise three-dimensional (3D) measuring capabilities. Yet in one embodiment, the magnetometer may be a group magnetometer, or a magnetometer array which provides magnetic field observation simultaneously from multiple locations spaced apart. The magnetometer may be an accurate sensor capable to detect any variations in the EMF. In addition to the strength, also known as magnitude, intensity or density, of the magnetic field (flux), the magnetometer may be capable of determining a 3D direction of a measured EMF vector. To this end, it should be noted that at any location, the Earth's magnetic field can be represented by a 3D vector. Let us assume that a compass needle is tied at one end to a string such that the needle may rotate in any direction. The direction the needle points, is the direction of the Earth's magnetic field vector.

As said, the magnetometer carried by a person in the mobile device 200 traversing the path 102 in FIG. 1 is capable of determining the 3D magnetic field vector. Example three components of the EMF vector as well as the total strength are shown in FIG. 2 throughout the path 102 from (X1, Y1) to (X2, Y2). The solid line 110 may represent the total strength of the magnetic field vector and the three other lines 112 to 116 may represent the three component of the 3D magnetic field vector. For example, the dot-dashed line 112 may represent the Z component (vertical component), the dotted line 114 may represent the X component, and the dashed line 116 may represent the Y component. From this information, the magnitude and direction of the measured magnetic field vector may be extracted.

In location tracking/discovery of mobile device 200 on the basis of the EMF measurements, or any target object moving in the building 100, each EMF vector measured by the mobile device 200 carried by a person may be compared to existing information, wherein the information may comprise EMF vector strength and direction in several locations within the building 100 or within a plurality of buildings. The information may thus depict an indoor Earth's magnetic field map. As the amount of data in the EMF map, typically covering many buildings, may be large, the EMF map may be stored in a cloud, such as in a database entity 250 or a server, instead of the mobile device 200 which typically has limited computational capabilities.

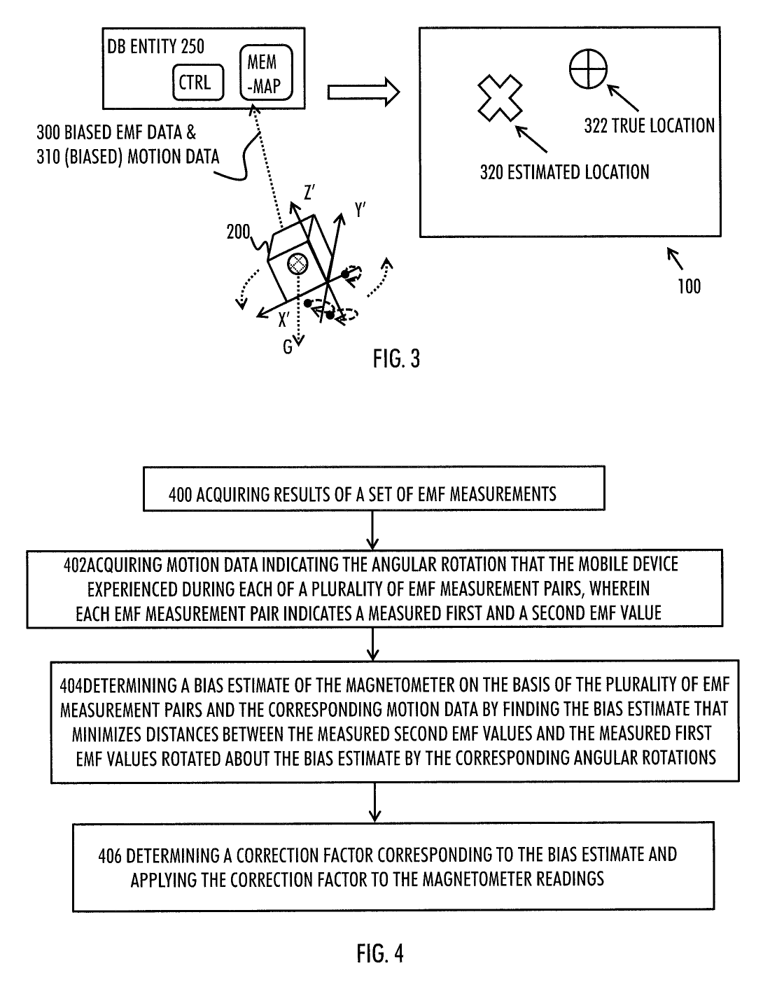

As shown in FIG. 3, the mobile device 200 may transmit EMF measurement results 300 to the database entity 250 in a network, i.e. to the cloud, which performs the comparison against the EMF map. The mobile device 200 may further transmit motion data 310 indicating, e.g., the linear and/or angular motion of the mobile device 200 during the time window corresponding to the transmitted EMF measurements results. The database entity 350 may then return a location estimate 320 to the mobile device 200. However, in another embodiment, the mobile device 200 may itself apply the stored EMF measurement results 300 for making the location/path estimate. In such case, the database entity 250 as used in the description may locate inside the mobile device 200. In such case, the mobile device 200 may also store the EMF map of the building 100, for example.

In order to provide accurate location discovery, it is important that the magnetometer provides reliable EMF measurements 300. However, often the magnetometer results (i.e. measurement results provided by the magnetometer) comprise a bias, such as an additive bias, which may distort the measurement so that the readings from the magnetometer are different than the true readings of the EMF at that location. For example, a 3-axis magnetometer may comprise bias in one or more of the directions. The additive bias means that bias values are summed to raw measurements, as M_{biased}=M_{raw}+b, where b stands for bias. This is different bias than, e.g., a multiplicative bias, where M_{biased}=b*M_{raw}. As a result, the estimated location 320 may not correspond to the true location 322 of the mobile device 200. Let us throughout the application consider that b represents additive bias.

A successful calibration of the sensor may compensate the bias and thus provide more accurate measurements. Calibrating the magnetometer in order to take the bias into account may be performed at certain predetermined locations, where the EMF is pre-measured. This true, pre-measured EMF reading may then be compared to the value measured by the magnetometer of the mobile device 200. However, such locations are not present in every building and the magnetometer may become distorted (e.g. due to additive bias) at any given time. Furthermore, this calibration process may require the user of the mobile device 200 to perform actions. Therefore, there exists a need to calibrate the magnetometer easily and reliably on-the-fly as a background process.

Therefore, there is proposed a method for compensating for the bias, as shown in FIG. 4. In an embodiment, it is assumed that the bias b_{magn} stays substantially constant during the calibration processes. An apparatus performing the embodiments described may comprise at least one processor and at least one memory including a computer program code, wherein the at least one memory and the computer program code are configured, with the at least one processor, to cause the apparatus to perform at least the method of FIG. 4. The apparatus performing the steps of FIG. 4 may be comprised in e.g. the mobile device 200 or the database entity 250, depending on the implementation of the calibration system. For the sake of simplicity of the description, let us assume that the method is performed by the mobile device 200.

In step 400, the mobile device 400 may acquire results of a set of EMF measurements 300, wherein each EMF measurement is performed by the magnetometer comprised in the mobile device 200 and indicates a measured EMF value M with respect to the orientation of the mobile device 200 at a measurement time. The set of EMF measurement results 300 may comprise two or more measurement results. Each EMF value M may indicate an EMF vector pointing to the measured EMF value M in a 3D coordinate system (X, Y, Z). Thus, each EMF value M may be a vector having three elements corresponding to the 3D coordinate system, defined as M=[x, y, z]^{T}, wherein the upper index T denotes a transpose. For a two-dimensional (2D) case, M=[x, y]^{T}. It may be noted also that, as shown in FIG. 3, the mobile device 200 may be rotated with respect to at least one of the following axes: a horizontal X-axis, a horizontal Y-axis, and a vertical Z-axis, as shown with X′, Y′ and Z′, respectively.

The received EMF measurement results may form pair of EMF measurements. Each EMF measurement pair may indicate a first and a second measured EMF value M₁ and M₂. In an embodiment, a given measurement pair corresponds to two consecutive EMF measurements results. In another embodiment, a given measurement pair does not correspond to two consecutive EMF measurements results, but there may be some EMF measurement results in-between the first and the second EMF measurement representing the first and the second EMF values M₁ and M₂.

Let us assume that the readings M₁ and M₂ represent the static magnetic field at a single location at two different points of time, and that the 3D (or 2D) orientation of the device 200 changed during the EMF measurement pair. Let us further assume there is no bias in the sensors, and that the measurements contain no noise.

Further, as said, the magnetometer readings M₁ and M₂ may depend on the orientation of the device 200. However, the norms (i.e. lengths) of the two vectors are the same. More precisely, as the device 200 is assumed to rotate in the static Earth magnetic field, the second measured magnetic field vector B (corresponding to value M₂) should be the same as the first vector A (corresponding to value M₁) rotated the same amount as the device 200, but in the opposite direction. In the Figures, R_{magn} represent the rotation between the vectors A and B.

In step 402, the mobile device 200 may acquire motion data 310 indicating the angular rotation R that the mobile device 200 experienced during each of a plurality of EMF measurement pairs, wherein each EMF measurement pair indicates a first and a second measured EMF value M₁ and M₂ and the motion data 310 is measured by at least one motion sensor comprised in the mobile device 200. The motion sensor may comprise, e.g., an inertial motion sensor, a gyroscope, an acceleration sensor, for example.

The motion data 310 may thus indicate how the 3-dimensional orientation of the mobile device 200 has changed between the time instant corresponding to the first EMF value and the time instant corresponding to the second EMF value. Such change in the orientation may be due to the person holding the mobile device 200 swinging his/her arm(s), due to the person turning, etc. Using the motion sensor measurements between the two measurement points, a net orientation change of the device 200 may be calculated. This change of orientation of the mobile device 200 from (X′₁, Y′₁, Z′₁) to (X′₂, Y′₂, Z′₂) may be detected by the motion sensor of the mobile device 200.

Any change in the device's 200 orientation may be described with a rotation matrix R. The motion data 310 may indicate the angular rotation R experienced by the device 200. The corresponding opposite rotation of a magnetic vector may similarly be described with a transpose R^{T}. As the context makes it clear whether R or R^{T} is meant in the description and Figures, let us in the following denote the rotation with R, for the reasons of simplicity.

However, the result of such rotation may depend on the origin about which the rotation is applied. If the magnetometer contains additive bias, then the value of the bias is the origin, which causes rotation of the first vector A to match to the second vector B. Performing the rotation about some other origin, for example, about the coordinate system origin (0,0,0), may cause the rotated vector A not to match vector B. Therefore, solving the bias b of the magnetometer may thus be likened to finding the correct origin of rotation. In order to illustrate the idea, we introduce a term test bias value b′, which denotes a tentative origin point

In step 404, the mobile device 200 may then determine the bias estimate b of the magnetometer on the basis of the plurality of EMF measurement pairs and the corresponding motion data. The motion data may indicate the angular rotation experienced during each EMF measurement pair. In an embodiment the determination of the bias estimate may take place by finding the bias estimate that minimizes distances between the measured second EMF values M₂ and the measured first EMF values M₁ rotated about the bias estimate b by the corresponding angular rotations R. In other words, by finding the bias estimate that minimizes distances between the measured second EMF values M₂ and predicted second EMF values M₂′, wherein the predicted second EMF values M₂′ are obtained by rotating the measured first EMF values M₁ about the bias estimate b by the corresponding angular rotations R. Thus, the predicted second EMF values M₂′ may also be called as bias-rotated second EMF values.

In an embodiment, the minimization is based on least squares minimization algorithm on squared distances, in order to find the value of bias estimate b that minimizes squared distances between the measured second EMF values M₂ and predicted second EMF values M₂′, as will be described later.

However, in an embodiment, the distances are not squared. In yet one embodiment, the minimization is based on finding the bias estimate in by using a Kalman filter algorithm, as will be described later.

However, for illustrative purposes, the method is now described by using the test bias b′. Therefore, let us next assume that the device 200 determines bias-rotated second EMF values M₂′ on the basis of the motion data 310, the measured first EMF value M₁, and predetermined test bias values b′ of the magnetometer.

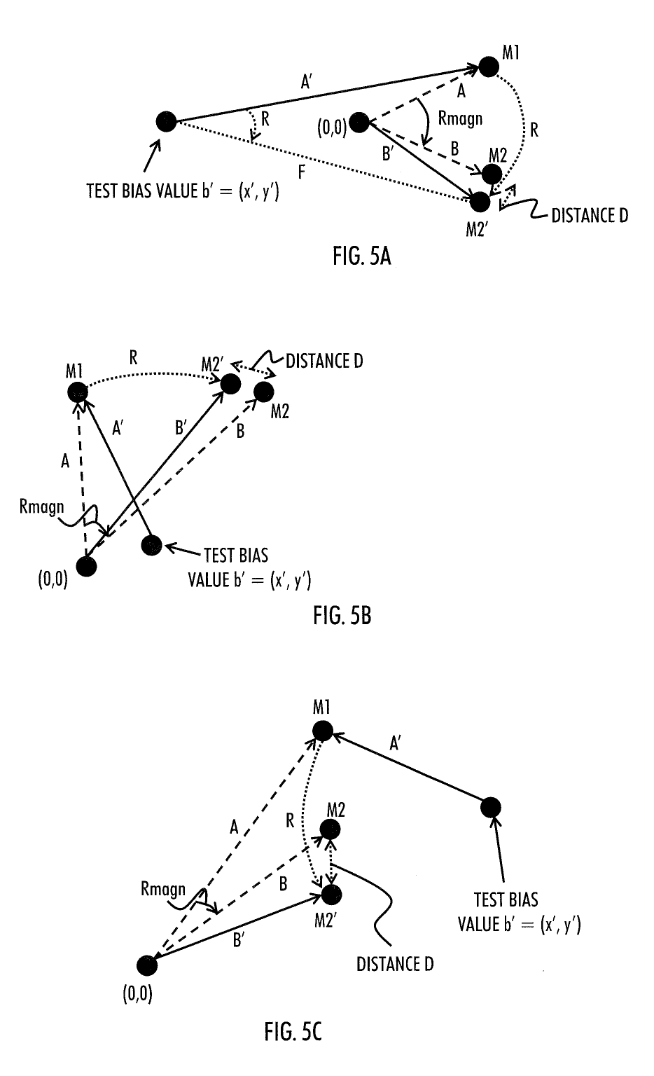

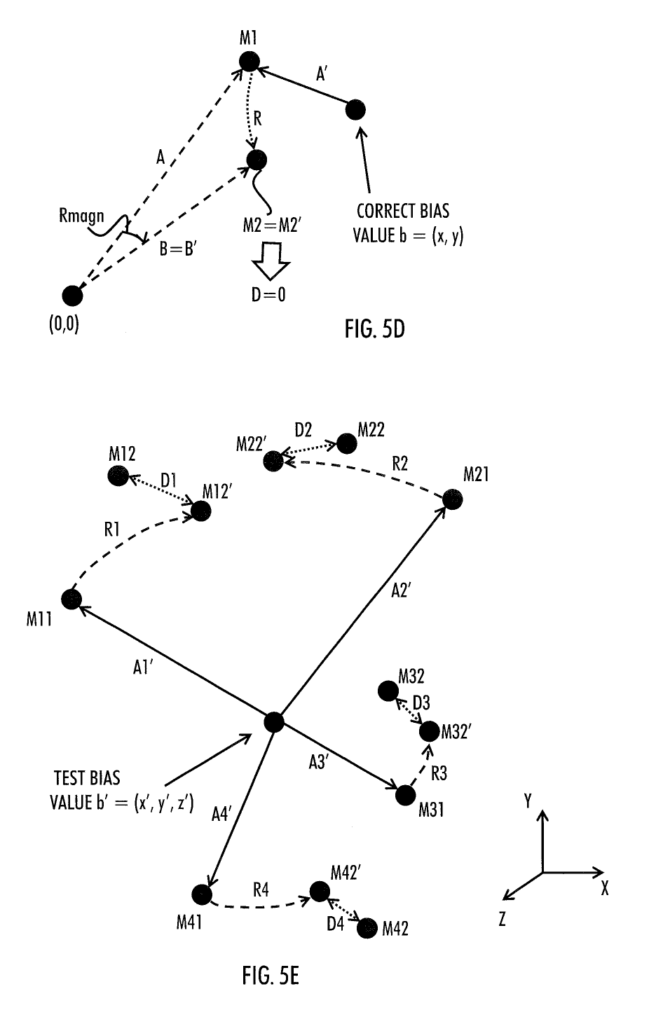

There may be several test bias values b′=(x′, y′, z′) that are tested. These bias values b′ may be predetermined and the test bias values b′ may span over the 3D space so that the correct bias b may be determined, as will be described. However, for simplicity, FIGS. 5A to 5C each show one test bias value b′.

Naturally, in practice the 3D case is valid. However, for the simplicity of the Figures, the two-dimensional case is depicted in most of the Figures.

First, let us rotate measurement M₁ around test bias b′. This may take place by moving the vector A to originate from the test bias point b′ to the reading M₁, as shown in FIGS. 5A to 5C. This may be performed with an expression M₁−b′. Let us mark this moved vector with a solid arrow A′=(M₁−b′) in Figures.

Let us then rotate the vector A′ according to the measured rotation R. Such rotation may be done as R(M₁−b′). This rotated vector R(M₁−b′) then points to a point which is marked as the bias-rotated second EMF value M₂′ in the Figures. FIG. 5A shows with a dotted straight arrow F how the rotation R and the first measurement value M₁ may be applied to reach the bias-rotated second EMF value M₂′, once the test bias value b′ has been selected.

Next, the bias-shifted, R-rotated vector R(M₁−b′) is taken back to the original coordinate system in which the point (0,0,0) is the origin, not the test bias point b′=(x′, y′, z′). This may be performed with an expression R(M₁−b′)+b′, which is denoted as vector B′.

As shown in FIGS. 5A to 5C, the vector B′ originates from the point (0,0,0) to the point M₂′ (not to M₂) in case of using test bias value b′=(x′, y′, z′) that differs from the correct bias value b=(x, y, z). In case the correct bias value b=(x, y, z) is used as the test bias value b′, then the vector B′ originating from the point (0,0,0) would point to M₂, instead of M₂′, still assuming that the measurements are free from noise. However, it should be noted that the correct bias b is unknown before applying the proposed calibration process.

The aim may thus be to find an accurate estimate for the correct bias b by testing several test bias values b′. It may be noted, as said, that if the magnetometer had no bias, then the reverse rotation (R^{T}) of the device 200 should closely map the first magnetometer measurement M₁ to the second M₂. Using this as an assumption, it may be possible to solve the value of the bias b in the 3D coordinate system that matches the rotation R to the two magnetometer measurements M₁ and M₂.

There may be several points in the 3D space that provide equally good matches between M₂ and M₂′ when looked from the point of view of one EMF measurement pair. Typically several EMF measurement pairs are used for the determination of the correct bias b.

The step 404 may comprise determining the bias estimate b of the magnetometer on the basis of a minimization criterion with respect to the measured second EMF values M₂ of the EMF measurement pairs and the bias-rotated (i.e. predicted) second EMF values M₂′ of the EMF measurement pairs.

In an embodiment, the vector defined as B′=R(M₁−b′)+b′ representing the point M₂′ (or M₂ in case b′ is at the correct bias location b) may be compared to the measured vector B representing the second EMF value M₂. In an embodiment, a difference may be determined as a subtraction vector D=B′−B=(R(M₁−b′)+b′)−M₂=−(M₂−b′). Thus, D may indicate how well the two vectors B and B′ match with each other. FIGS. 5A-5D show distances D between the measured points M₂ and the corresponding bias-rotated points M₂′. Only one EMF measurement pair in a two-dimensional coordinate system is used in these Figures for simplicity.

FIG. 5A shows a case where the rotation R_{magn} on the basis of the magnetometer readings M₁ and M₂ with respect to the origin (0,0) is different than the rotation R of the device as determined on the basis of the motion data 310. However, the lengths (i.e. norms) of the A and B may be equal. Nevertheless, because the rotation does not match, it may be decided that additive bias is most likely present in the magnetometer readings. Therefore, as shown in the figures, vectors A′ and B′ may be formed, explained earlier, with respect to several test bias values b′ (only one b′=(x′, y′) is shown in FIG. 5A). As a result, for each test bias value b′, M₂′ is determined and the distance vector D may be calculated between M₂ and M₂′.

FIG. 5B on the other hand shows a case where the rotation angle R_{magn} on the basis of the magnetometer readings M₁ and M₂ with respect to the origin (0,0) is the same as the rotation angle R of the device as determined on the basis of the motion data 310. However, the lengths (i.e. norms) of the A and B are not the same, meaning the rotation of A about (0, 0) with R_{magn} does not yield B. Therefore, it may be decided that additive bias is most likely present in the magnetometer readings. Therefore, as shown in FIG. 5B, vectors B′ may be formed with respect to several test bias values b′ and, consequently, the difference vectors D may be determined for each test bias value.

In FIG. 5C, it may be noted that R_{magn} is not the same as the measured rotation R. Moreover, the norms (lengths) of A and B are not the same. Therefore, it may be decided that additive bias is most likely present in the magnetometer readings. Therefore, as shown in the figures, vectors B′ may be formed with respect to several test bias values b′ and, consequently, the differences D may be determined for each test bias value.

FIG. 5D, on the other hand, shows a case where a correct bias b estimate has been determined. In such case, as explained earlier, vectors B and B′ are the same because M2 is the same as M2′. Therefore, once the correct bias b is established, the distance vector D may be zero.

However, as said, one measurement pair may not be enough to yield a reliable estimate of the correct bias value b. FIG. 5E then shows an application of several EMF measurement pairs providing several first and second EMF values. In this example, four pairs are used. The first and second EMF values are denotes as Mᵢ₁ and Mᵢ₂, respectively, where i denotes the index of the EMF measurement pair. Similarly, the determined distances D and the corresponding rotations R obtained from the motion data 310 are marked as Dᵢ and Rᵢ, respectively. Thus, Dᵢ=Bᵢ′−Bᵢ=(R₁(Mᵢ₁−b′)+b′)−Mᵢ₂=Rᵢ(Mᵢ₁−b′)−(Mᵢ₂−b′).

In an embodiment, the device 200 determines the bias estimate b by using a minimization criterion with respect to the distances D. The smaller the distances, the closer the test bias value b′ is to the correct bias estimate b. Accordingly, in an embodiment the mobile device 200 determines, for each test bias value b′, a value of loss function L based on distances between the bias-rotated second EMF values M₂′ and the measured second EMF values M₂ over the plurality of EMF measurement pairs. This may mean 1) determining, for each test bias value b′ in each of the plurality of EMF measurement pairs, a distance D between the bias-rotated second EMF value M₂′ and the measured second EMF value M₂, 2) determining, for each test bias value b′, the value of loss function L over the plurality of EMF measurement pairs. The loss function may be given as:

$$L ( {b}^{′} ) = {\sum }_{i = 1}^{{N}_{PAIR}} {‖ {D}_{i} ‖}^{2}$$

In the equation, N_{PAIR} is the number of EMF measurement pairs. It may be noted that the number of EMF measurement pairs may comprise only those pairs that are considered valid and are taken into account in the determination of the bias estimate b.

Thereafter, the mobile device 200 may determine which of the test bias values b′ provides a minimum value for the loss function L. Thus, the aim may be to minimize the loss function L. A minimized L may denote that the corresponding test bias value b′ (=bias estimate b) is at least close to the correct bias bₜᵣᵤₑ of the magnetometer.

In an embodiment, and as shown in the above equation, the loss function is the sum of squared distances Dᵢ between the measured second EMF values Mᵢ₂ and the bias-rotated second EMF values Mᵢ₂′ of the EMF measurement pairs with respect to a given test bias value b′. Loss function of this form may be advantageous for efficient minimization, e.g. using least squares minimization techniques. Thus, the test bias b′, that minimizes the squared distances between the bias-shifted and rotated vectors B′ to the second vectors B for the measurement pairs, is determined directly.

Thereafter, the mobile device 200 may select that test bias value b′, which provides the minimum value for the loss function L, as the bias estimate b of the magnetometer.

Looking at FIG. 5E closer, there are four EMF pairs in a 3D coordinate system (X, Y, Z). There may have been many test bias values b′ tested. However, after trying these test bias values b′ and determining L for each of the test bias values b′, it may have been detected that the shown bias value b (locating in a point x,y,z of the (X,Y,Z) coordinate system) is the one that provides the minimum L. Therefore, this bias value b is taken as the bias estimate b of the magnetometer.

There may not be a single bias value that matches perfectly (with a zero-distance) in every M₂-M₂′ pair. This may be due to noise in a relevant sensor, such as in the magnetometer and/or in the motion sensor, or due to non-static magnetic field (even changes of a few centimeters may affect the measured EMF). However, the test bias value b′ which provides a minimum L is, with a high likelihood, very close to the correct bias bₜᵣᵤₑ. Therefore, this b′ may be selected as the bias estimate b of the magnetometer.

In an embodiment, the bias estimate b is selected among the tested bias values b′. This provides ease of complexity. In another embodiment, the bias estimate b is selected on the basis of the tested bias values b′, such as by taking an average of two or more bias values b′ that provide small L. In yet an embodiment, bias estimate b is directly solved by analytical minimization of the loss function L, for example, by using least squares minimization techniques.

In step 406 the mobile device 200 may determine a correction factor α_{magn} corresponding to the determined bias estimate b and apply the correction factor α_{magn} to the magnetometer readings. This may be advantageous in order to remove the bias from the magnetometer readings so as to obtain substantially true EMF value at any given location. This may improve the accuracy of the location tracking and estimation of the EMF based location-technique. It may be worth noting that the proposal makes no assumption of the evolution of the measured EMF vector norms over the length of calibration process. This may advantageously allow walking while calibrating, making the calibration method suitable to be performed as an automatic background process of the magnetometer, hidden from the user of the device and requiring no user interaction except swinging the mobile device, which typically happens automatically as the person carried the mobile device 200.

Although the Figures do not illustrate a 3-dimensional case, it is clear to a person skilled in the art that the proposed method may in practice be implemented in the 3-D system and the teachings given above may be readily used in the 3-D space.

For example, the least squares solution for the bias estimate b may be given as:

b=PHS,

where H=[I−R₁; I−R₂; . . . ; I−R_{N}_{_{PAIR}}], which is a 3N_{PAIR}*3 matrix, N_{PAIR} is the number of EMF measurement pairs, I is 3×3 identity matrix, Rᵢ denotes the measured rotation between the magnetic measurement pair Mᵢ₁ and Mᵢ₂, S=[M₁₂−R₁M₁₁; M₂₂−R₂M₂₁; . . . ; M_{N}_{_{PAIR}}₂−R_{N}_{_{PAIR}}M_{N}_{_{PAIR}}₁] which is a column vector having a length of 3N_{PAIR}. We denote P=(H^{T}H)⁻¹, and call P the covariance matrix.

In one embodiment, the consecutive EMF pairs are not overlapping. This may provide reliable bias estimate b as new pairs comprising new EMF values M₁ and M₂ are used.

In another embodiment, at least some of the consecutive EMF pairs are overlapping so that the second EMF value of one pair is also the first EMF value of the next pair. For example, in case of six consecutive measurements (1, . . . , 6), the pairs may be formed as 1-2, 2-3, 3-4, 4-5, 5-6, This may be efficient. In this embodiment, only three magnetometer readings may be sufficient for accurately determining the correct bias estimate b.

In an embodiment, arbitrary pairs may be formed from the EMF measurements. For example, in the case of six consecutive measurements (1, . . . , 6), the pairs may be formed as 1-2, 1-3, 1-4, 2-4, 2-5, 2-6, to mention only a few non-limiting options. This may provide flexibility for the pair formation. For example, if one EMF measurement result

In an embodiment, the bias estimate b is estimated at once by applying the amount of data collected so far with all valid (to be discussed later) EMF measurement pairs collected so far. In another embodiment, the bias is estimated by updating each previously obtained estimate of the bias with a new, valid EMF measurement pair.

In an embodiment, an existing bias estimate b, obtained e.g. by the least squares minimization discussed earlier, is updated using new measurement data. This may be accomplished by using a well-known technique for recursively updating a solution to linear least squares minimization problem. This produces the exact same solution as solving the least squares problem directly by using all the data. This way the algorithm for solving the bias b may run in real-time without scaling issues due to increasing amount of data. The process may be initialized by solving the minimization problem, as indicated above, and saving the covariance matrix P=(H^{T}H)⁻¹. The least squares bias estimate b may then be updated along the matrix P.

In an embodiment, it is assumed that an existing bias estimate b and an existing covariance matrix P are already determined. The following example update steps may then be performed once per new pair of magnetic measurements.

Denote the new index of new measurement pair with i. Each update may be split into three steps, one for each coordinate of the 3D coordinate system. For m=1, 2, 3, it may be calculated:

S=Mᵢ₂−RiMᵢ₁ and Sₘ is the m^{th} element of the vector S,

A=I−Rᵢ,

h=(Aₘ)^{T}, which defines h as a transpose of the m^{th} row of the matrix A,

K=Ph(h^{T}Ph+λ)⁻¹, where λ is an optional forgetting parameter; and thereafter the updates may be performed as:

P_{new}=(1/λ)(I−Kh^{T})P, which updates the covariance matrix; and

b_{new}=b+K(Sₘ−h^{T}b), which finally updates the bias estimate.

In an embodiment, where the previous bias estimate b is updated after a new measurement pair, a parameter (e.g. λ above) may be used to weight the new measurement pair more than the previous measurement pairs. For example, if λ<1 in the above update steps, then the continuous estimation may weigh the new data more than previous. If λ is equal to one (λ=1), all data may be considered equal, and there is no “forgetting” behaviour. This corresponds to solving the regular least squares minimization. Such use of a forgetting parameter may be advantageous because if the calibration is run for a long time, during which magnetometer bias changed, the bias estimate may change faster to the correct value by weighting the new measurements more.

As said, in another embodiment, Kalman filtering algorithm, which is known to a skilled person, may be applied for solving the minimization problem in the case of overlapping pairs. Let us assume that the measured magnetic vectors comprise bias b and Gaussian noise. Instead of assuming that b is exactly constant, a random walk model may be introduced on the bias. It may also be assumed that rotations of magnetic vectors comprise Gaussian noise. In the Kalman filter algorithm, the model may be written as a standard Kalman filter compatible state-space model and the bias may be estimated recursively by applying the Kalman filter-technique known to a skilled person. It may be noted also that in some cases (e.g. when using overlapping pairs with no forgetting behavior and assuming that there is no noise due to rotations), the Kalman filter algorithm produces the same bias estimates as the least squares minimization algorithm. However, with the Gaussian noise model and the random walk model, the Kalman filter algorithm may take into account model inaccuracies and time-variance in the bias

It may be noted that the benefit of using the least squares technique for the minimization may be that the forgetting mechanism (e.g. the use of λ) may be more efficient than the use of the “random walk” in the Kalman technique. Further, the least squares technique may be beneficial in that arbitrary pairs may be formed from the consecutive measurements (see above the description related to arbitrary pairs). However, in the Kalman filtering, the pairs to be formed may need to be overlapping in the form of 1-2, 2-3, 3-4, 4-5, 5-6 , for example.

In one embodiment, a reliability metric of the bias estimate in each direction of the 3D space may be determined, wherein the reliability metric is based on the motion data 310. In an embodiment, as shown above, the matrix P, which is updated in the continuous estimation implementation, is the covariance matrix of the estimate error and may thus be used to estimate quality of the bias estimate b. The three diagonal elements of the covariance matrix P are the variances of the bias estimate b in each coordinate of the (X,Y,Z) coordinate system. A large variance may mean uncertain estimate, and a small value may denote a reliable estimate. For example, suppose the device is calibrated while placed on a table display up, and rotated there without lifting it up. In this case, the motion data becomes “degenerated” in a way that only the horizontal X and Y coordinates (axes along the table) of the bias vector may be estimated reliably, and the vertical Z coordinate (axis up from table) may be uncertain. In the covariance matrix P then, the diagonal values corresponding to X and Y coordinates may be relatively small and the Z value may be relatively large. In such case, the calibration process may be further continued to obtain a more reliable estimate of the bias b in the Z direction as well. For example, if, during the continued calibration, the device 200 is rotated more variedly, all of the three diagonal elements may become relatively small. Thereafter, in an embodiment, the calibration process may be automatically terminated when a predetermined level of reliability has been achieved in all directions (X, Y,Z). In an embodiment, the termination is only temporal so as to enable recalibration after a predetermined duration. This may be advantageous as the bias may change in time. Alternatively, instead of examining the diagonal components of the covariance matrix, its eigenvalues can be used in a similar fashion.

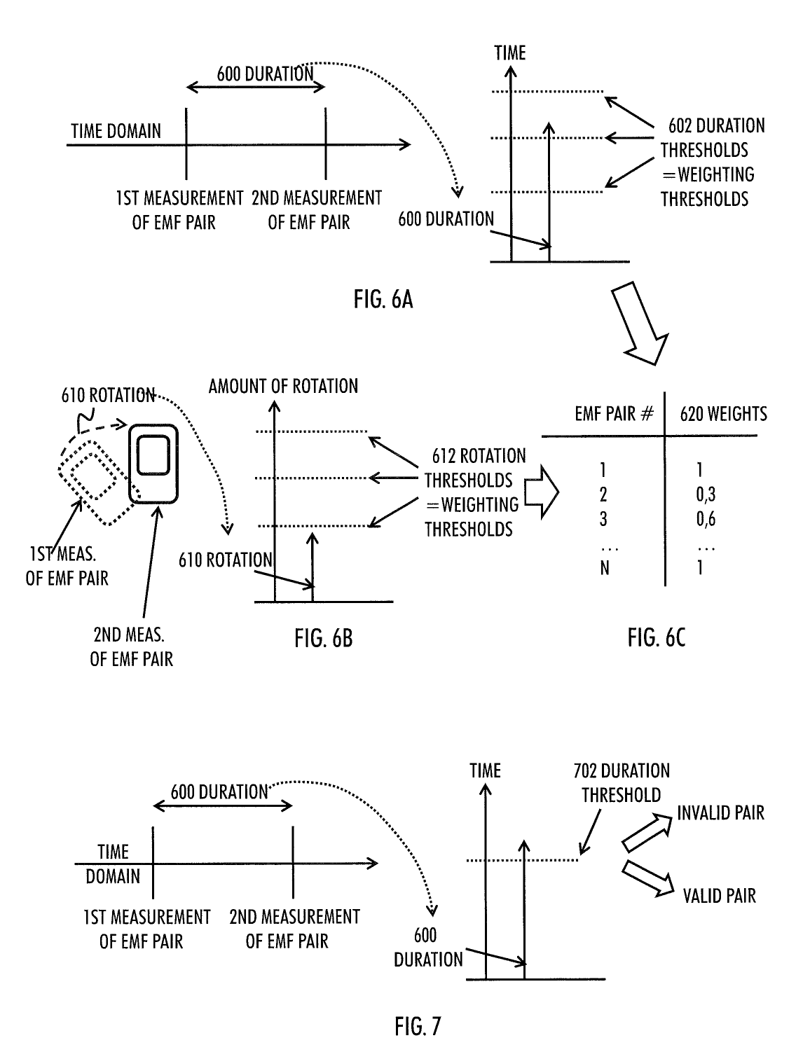

In an embodiment, as shown in FIGS. 6A-6C, at least one EMF pairs may be given more weight in the determination of the bias than the other EMF pairs. These weights may be based on an estimated quality of the input data, which includes the motion data 310 and the EMF data 300.

For simplicity, formulas presented earlier presumed uniform weighting of (valid) EMF pairs. Use of weight factors w may be introduced with small modifications to the formulas, as known to a person skilled in the field concerning linear least squares algorithms. For example, the loss function may then be given as

L(b′)=Σᵢ₌₁^{N}^{_{PAIR}}wᵢ∥Dᵢ∥², where ∥x∥ denotes a norm of x.

In an embodiment, the mobile device 200 may compare at least one property of each of the EMF measurement pairs with a predetermined at least one weighting threshold 602, 612. In an embodiment, the at least one property comprises at least one of the following: angular velocity determined on the basis of the motion data 310, angular acceleration determined on the basis of the motion data 310, amount of rotation R determined on the basis of the motion data 310, time duration 600 between the first and the second EMF measurement, a difference between the first and the second EMF measurement (∥M₂−M₁∥), to mention only a few possible options.

For example, FIG. 6A shows a plurality of weighting thresholds 602. Thus, the duration 600 may be compared against these thresholds 602. In case the duration is longer than a given threshold 602, the weight factor may be decreased. In case the duration 600 is smaller than the lowest duration threshold 602, the weight factor may be high.

FIG. 6B on the other hand shows how the total rotation 610 may be detected and compared against rotation thresholds 612. Here, it may be that the larger the rotation 610, the better the estimate of the bias may be. Therefore, the weight factor for larger rotations 610 may be higher than the weight factor for smaller rotations 610.

In case the angular velocity is detected to be high, then the quality of the estimate may not be as good as it would be if the angular velocity was low. In such case, the weight factor for this EMF measurement pair may be lower than in case where the angular velocity is lower. This may be e.g. because gyroscopes (as a possible motion sensor) are not as accurate at high angular velocities as they are in low angular velocities.

The predetermined weighting thresholds 602, 612 and also other weighting factors corresponding to a respective determined property (such as angular velocity weighting factors for the determined angular velocity) may be e.g. empirically derived or based on mathematical modelling.

After the comparison, the mobile device 200 may determine the weight factor 620 for this EMF measurement pair on the basis of the comparison result, as shown in FIG. 6C. Thereafter, the mobile device 200 may apply the weight factor 620 in weighting the relevance of the EMF measurement pair for the determination of the bias.

The values of the weight factor may as well be empirically or mathematically derived. The weight factor value may, in an embodiment, be any positive value. The exact value may be determined with a plurality of corresponding thresholds, each threshold being associated with a specific weight factor value. The associations may be empirically or mathematically derived so as to result in reliable determination of the bias. However, in an embodiment, the weight factor 720 takes a value of 1 or 0.

In an embodiment, some EMF measurement pairs may be detected to be unreliable for reasons of, e.g., long duration 600, small rotation 610, high angular velocity, etc. In such case, the mobile device 200 may discard these unreliable EMF measurement pairs as invalid pairs. Let us look at this embodiment next.

In an embodiment, the device 200 may determine, on the basis of the determined at least one property, whether the corresponding EMF measurement pair is a valid or an invalid EMF measurement pair. Upon detecting that the EMF measurement pair is valid, the device 200 may decide to apply the EMF measurement pair in the determination of the bias. However, upon detecting that the EMF measurement pair is invalid, the device 200 may decide not to apply the EMF measurement pair in the determination of the bias. Not using a given measurement pair in the determination of the bias may correspond to weighting the given EMF pair with a zero weight factor. This may provide a simple manner of dividing EMF pairs into valid and invalid pairs.

As an example, as shown in FIG. 7, the mobile device 200 may compare the time duration 600 between the first and the second EMF measurement of the EMF measurement pair with a predetermined duration threshold 702. As shown the duration 600 between the EMF measurements indicating M₁ and M₂ exceeds the duration threshold 702. In this case, upon detecting that the time duration 600 exceeds the duration threshold 702, the mobile device 200 may decide not to apply the EMF measurement pair in the determination of the bias. Thus, this measurement pair may be defined as invalid. This may be because the duration 600 between the measurements is too long so that it may not be reliably expected that the static magnetic field has remained the same during the time period 600. For example, the person carrying the phone may have moved too much. However, upon detecting that the time duration 600 is less than the duration threshold 702, the mobile device 200 may device to apply the EMF measurement pair in the determination of the bias. As such, this kind of measurement pair may be denoted as a valid EMF pair. The predetermined duration threshold 702 may be e.g. empirically derived or based on mathematical modelling.

In another example embodiment, the mobile device 200 detects, on the basis of the motion data 310, that the person carrying the mobile device 200 has moved, wherein the motion data 310 indicates linear motion. The motion sensor of the device 200 may comprise e.g. an accelerator, an odometer, etc. Then the mobile device 200 may determine the amount of motion, e.g. in meters, between the first measurement of a given EMF measurement pair and a second measurement of the given EMF measurement pair. In case it is determined that the amount of linear motion exceeds a predetermined linear motion threshold, then the mobile device 200 may decide to determine the corresponding EMF measurement pair as invalid and not to use it in the determination of the bias estimate b. However, in case it is determined that the amount of linear motion does not exceeds a predetermined linear motion threshold, then the mobile device 200 may decide to determine the corresponding EMF measurement pair as valid and use it in the determination of the bias estimate b. The predetermined linear motion threshold may be empirically derived. The threshold may represent how much the person may move without the magnetic field changing. This value may depend on the environment, so the linear motion threshold may be environment and/or building specific.

Further, in case several properties (such as the duration 600 and the rotation 610) are determined and, thus, several corresponding threshold categories (e.g. thresholds 602 and 612, respectively) may be applied in the comparison, then there may be several, possibly different, weight factors obtained (e.g. one from the process of FIG. 6A and one from the process of FIG. 6B). In such case, there may be predetermined rules on how to combine these several, possibly different, weight factors. Again, these rules may be empirically or mathematically derived so as to result in reliable determination of the bias.

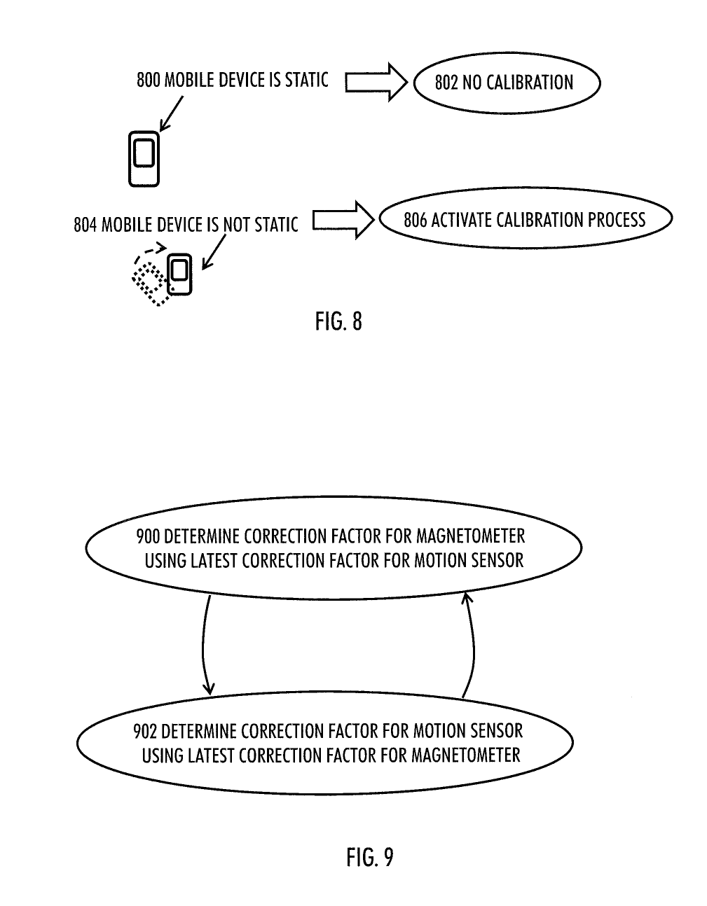

In an embodiment shown in FIG. 8, the mobile device 200 may detect, on the basis of the motion data 310, that the mobile device 200 is static as shown with reference numeral 800. In such case, the calibration process may not work as the experienced angular rotation is substantially zero. Therefore, upon detecting that the mobile device 200 is static (=no rotation), the mobile device 200 may, in step 802, restrain from performing the calibration process of the magnetometer. This may correspond to using a zero weight factor for the EMF measurement pair. However, upon detecting that the mobile device 200 is not static (i.e. rotates), as shown with reference numeral 804, the mobile device 200 may decide in step 806 to trigger/activate the process for the determination of the bias. The weight factor used for the valid pair may be one, or it may have a value depending on the thresholds, similarly as discussed with reference to FIGS. 6A and 6B

In an embodiment, the mobile device 200 (or the database entity 500) may filter the magnetometer readings 300 prior to using the magnetometer readings in the determination of the bias. The filtering may be performed in real-time before supplying the data 300 to the calibration algorithm. Such procedure may increase the performance of the algorithm in case the sensor data 300 is noisy. For example, a finite impulse response (FIR) or an infinite impulse response (IIR) filter may be used. In an embodiment, the motion data 310 is filtered in a similar manner as explained for the EMF data 300.

In an embodiment, the mobile device 200 is in an unknown location and in an unknown 3D orientation. Therefore, the calibration procedure may be performed at any time, even without knowing the location of the person carrying the mobile device 200.

As indicated in FIG. 3, bias may affect the motion sensor of the mobile device 200 as well, which may cause the motion data 310 to be biased. In such case, the rotation R determined from the motion sensor data 310 may not correspond to the true rotation Rₜᵣᵤₑ. However, as the proposed calibration process uses the motion sensor measurements for calibrating the magnetic sensor (e.g. the magnetometer), it may be important that any bias bₘₒₜᵢₒₙ in the motion sensor is compensated.

Therefore, the mobile device 200 may determine a correction factor αₘₒₜᵢₒₙ for the at least one motion sensor of the mobile device 200. This determined αₘₒₜᵢₒₙ may then be advantageously used in correction the values provided by the motion sensor of the device 200 and therefore to reduce the bias b_{motion of} the motion sensor.

In an embodiment the mobile device 200 may estimate the second EMF value M₂′ of a given EMF measurement pair on the basis of the angular rotation R measured by the at least one motion sensor and the determined bias estimate b′ of the magnetometer. Further, the first value M₁ may be used. Then the mobile device 200 may determine a correction factor for the at least one motion sensor of the mobile device 200 on the basis of the estimated (i.e. predicted) second EMF value M₂′ and the second measured EMF value M₂ of the given EMF measurement pair. Many EMF measurement pairs may be analysed for the determination of the correction factor for the motion sensor. This may advantageously allow for compensating additive bias errors of the motion sensor. It may be appreciated that the calibration of the motion sensor (e.g. the determination of the bias bₘₒₜᵢₒₙ of the motion sensor) may advantageously be performed as a background process, thus allowing e.g. walking while calibrating. Thus, the calibration of the motion sensor may be hidden from the user of the device and requiring no user interaction except swinging the mobile device, which typically happens automatically as the person carried the mobile device 200.

In an embodiment, the correction factors for the magnetometer and for the motion sensor are iteratively determined in steps 900 and 902 of FIG. 9. Each time the correction factor α_{magn} for the magnetometer is under determination, motion data 310 corrected by the correction factor αₘₒₜᵢₒₙ of the motion sensor is used. Similarly, each time a correction factor αₘₒₜᵢₒₙ for the motion sensor is under determination, magnetometer readings 300 corrected by the correction factor α_{magn} of the magnetometer are used.

In other words, the motion sensor bias bₘₒₜᵢₒₙ is determined by using the same data 300, 310 as used for calibrating the magnetometer. This is because the motion sensor bias bₘₒₜᵢₒₙ may be estimated given an estimate of the magnetic bias b_{magn}, using the EMF measurement pairs and the associated rotations R as was done in the determination of the magnetometer bias b_{magn}. In case there is a non-zero motion sensor bias bₘₒₜᵢₒₙ, and the EMF vector rotations are calculated relative to the estimated magnetic bias b_{magn}, there may be a systematic error detectable between the rotated first vectors and the measured second vectors (B, B′). This systematic error may be a rotation about an axis that goes through the magnetic bias b_{magn}. This rotation due to the systematic error may describe constant angular velocity that is being added to the measurements, i.e. the additive bias b_{motion of} the motion sensor. This rotation may be quantified, e.g., with a least squares based method, yielding a numeric estimate of the motion sensor additive bias bₘₒₜᵢₒₙ. The correction factor αₘₒₜᵢₒₙ may then be derived on the basis of the bias bₘₒₜᵢₒₙ.

The accuracy of both of the bias estimation methods depends on the amount of bias in the other sensor. In an embodiment, upon detecting that the correction factors α_{magn}, αₘₒₜᵢₒₙ the magnetometer and of the motion sensor, respectively, converge on of a predetermined convergence criterion, deciding that the corrected readings of the magnetometer and of the motion sensor are reliable. Thus, after convergence of the estimated bias values b_{magn} and bₘₒₜᵢₒₙ, it may be decided that both sensors have been calibrated successfully. The convergence criterion may be empirically or mathematically derived so that the reliability of the calibration processes are sufficient to provide accurate location tracking & estimation.

In an embodiment, the apparatus performing the embodiments is comprised in the mobile device 200, in which case the apparatus may further comprise the magnetometer configured to perform measurements of the EMF and the at least one motion sensor configured to measure the angular rotation of the apparatus.

Although the description has been written by using the magnetometer and EMF readings as an example, the embodiments are similarly applicable to a calibration of any rotation-dependent sensor, such as the magnetometer or a sensor measuring radio frequency (RF) signals (e.g. WiFi/wireless local area network). In an embodiment, the location tracking and/or estimation may be, instead of the EMF-based technique or in addition to the EMF-based technique, performed by measuring the strength and/or direction of the RF signals. This may take place by comparing the measured RF signals (e.g. strength and/or direction) to a database indicating RF signal strength and/or direction in a given location of the building. This may improve the location estimation and/or tracking. Thus, it may be beneficial to calibrate the RF signal receiver of the mobile device 200.

Although described so that the mobile device 200 performs at least one of the described embodiments, the database entity 250 may instead be the entity performing at least one of the described embodiments.

In an embodiment, there is provided a method for correcting the 3D orientation of the device 200 into a predetermined 3D coordinate system. The motion data 310 may indicate the 3D orientation of the mobile device 200 at the at least one time instant when the EMF data 300 is measured by the mobile device 200. As indicated in FIG. 3, the orientation may be defined in the frame of reference (X′, Y′, Z′) of the mobile device 200. However, (X′, Y′, Z′) may not be the same as the predetermined coordinate system (X, Y, Z). Thus, error in the location tracking & estimation may occur without adjusting/rotating/correcting the acquired EMF data from the frame of reference (X′, Y′, Z′) of the mobile device 200 to the frame of reference (X, Y, Z). It may be noted that the frame of reference (X, Y, Z) may be assumed to correspond to the frame of reference of the floor plan of the building 100. It should be noted that although observing the magnitude of the EMF may in some cases be sufficient for the location estimation/tracking, observing the direction of the EMF vectors may provide additional accuracy and efficiency.

Therefore, the database entity 250 or the mobile device 200 itself may apply the motion data 310 for determining at least one angle estimate of a difference between the 3D orientation of the mobile device 200 and the (X,Y,Z) coordinate system. For example, in order to determine the amount of rotation about the Y-axis and about X-axis, the mobile device 200 may be in one embodiment equipped with the motion sensor. The IMU may comprise at least one acceleration sensor utilizing a gravitational field. The IMU may optionally also comprise other inertial sensors, such as at least one gyroscope, for detecting angular velocities, for example. The acceleration sensor may be capable of detecting the gravitational force G. By detecting the acceleration component G caused by the Earth's gravitation, the mobile device 200 may be able to determine the amount of rotation about axis X and/or Y. The rotation about the Z-axis may be compensated, e.g., by using the information given by the gyroscope, by using the information of a true direction of the EMF which may be based on the EMF map for the area, or by using information of a dominant movement direction (such as the movement direction of the person carrying the mobile device), wherein the dominant movement direction may be derived from the motion data from the mobile device. In an embodiment, the IMU may detect the movement of the person carrying the mobile device 200. This may advantageously allow, e.g., the speed and direction of the person to be determined. Further description about the correction of the unknown 3D orientation of the mobile device 200 carried by a person may be found from U.S. patent application Ser. Nos. 13/739,640 and 13/905,655, the contents of which are incorporated herein by reference.

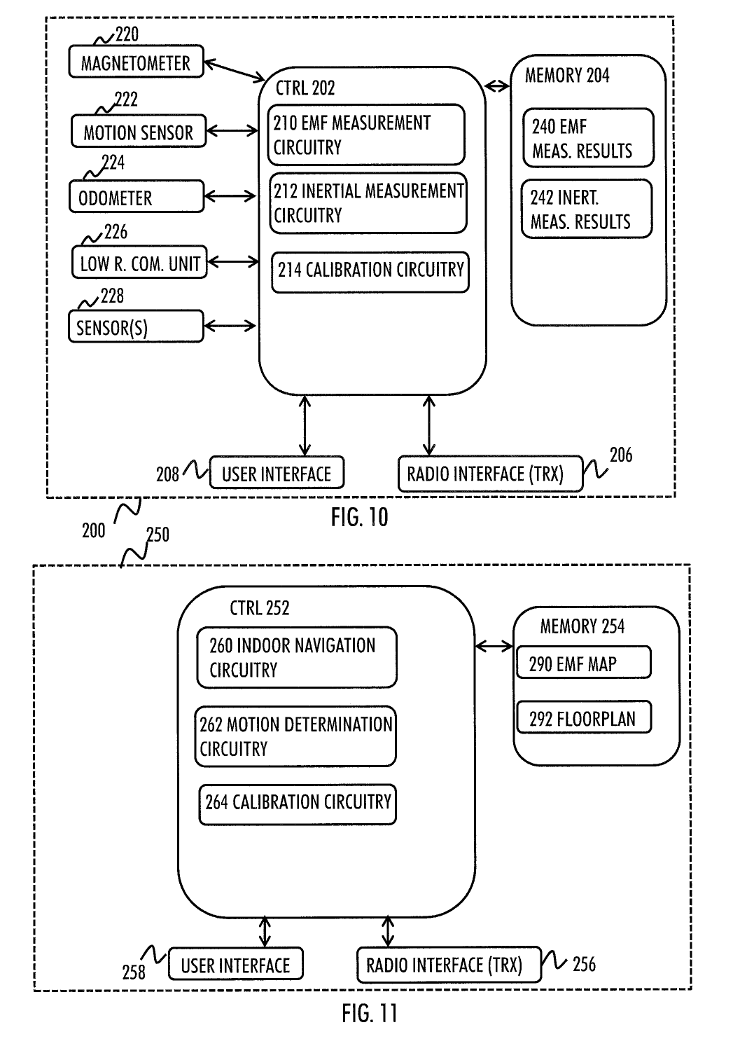

Embodiments, as shown in FIGS. 10 and 11, provide apparatuses 200 and 250 comprising at least one processor 202, 252 and at least one memory 204, 254 including a computer program code, which are configured to cause the apparatuses to carry out functionalities according to the embodiments. The at least one processor 202, 252 may each be implemented with a separate digital signal processor provided with suitable software embedded on a computer readable medium, or with a separate logic circuit, such as an application specific integrated circuit (ASIC).

The apparatuses 200 and 250 may further comprise radio interface components 206 and 256 providing the apparatus 200, 250, respectively, with radio communication capabilities with the radio access network. The radio interfaces may be used to perform communication capabilities between the apparatuses 200 and 250. The radio interfaces may be used to communicate data related to the measured EMF vectors/values, to location estimation, motion data, etc.

User interfaces 200 and 250 may be used in operating the mobile device 420000 and the database entity 250 by a user. The user interfaces may each comprise buttons, a keyboard, means for receiving voice commands, such as microphone, touch buttons, slide buttons, etc.

The apparatus 200 may comprise the terminal device of a cellular communication system, e.g. a computer (PC), a laptop, a tabloid computer, a cellular phone, a communicator, a smart phone, a palm computer, or any other communication apparatus. In another embodiment, the apparatus is comprised in such a terminal device, e.g. the apparatus may comprise a circuitry, e.g. a chip, a processor, a micro controller, or a combination of such circuitries in the terminal device and cause the terminal device to carry out the above-described functionalities. Further, the apparatus 200 may be or comprise a module (to be attached to the terminal device) providing connectivity, such as a plug-in unit, an “USB dongle”, or any other kind of unit. The unit may be installed either inside the terminal device or attached to the terminal device with a connector or even wirelessly.

In an embodiment, the apparatus 250 as the database entity, may locate in the network. In such case, the apparatus 250 may be or be comprised in a server computer. In another embodiment, the apparatus 250, as the database entity, may locate within the mobile device 200.

As said, the apparatus 200, such as the mobile device, may comprise the at least one processor 202. The at least one processor 202 may comprise an EMF measurement circuitry 210 for performing EMF measurements with the help of a magnetometer 220. An inertial measurement circuitry 212 may be for performing motion related measurements with the help of the motion sensor 222 or an odometer 224, for example. A calibration & correction circuitry 214 may be responsible of performing the proposed calibration process for the magnetometer 220 and/or for the motion sensor 222, for example.

The magnetometer 220 may be used to measure the EMF vector. There may be various other sensors or functional entities comprised in the mobile device 200. These may include an motion sensor 222, the odometer 224, a low range communication unit 226 for detecting the presence of a proximity communication signal, other sensors 228, such as at least one camera, a radio frequency sensor for detecting e.g. WiFi signals, for example. A skilled person understood that these may be of use when performing the embodiments as described earlier. For example, the motion sensor 222 may comprise an acceleration sensor and/or a gyroscope, for example.

The memory 204 may comprise space 240 for storing the EMF measurement results 300 and space 242 for storing the inertial measurement results (e.g. the motion data 310).

The apparatus 250, such as the database entity, may comprise the at least one processor 252. The at least one processor 252 may comprise several circuitries. As an example, an indoor navigation circuitry 260 for performing indoor navigation on the basis of the received set of Earth's magnetic field measurement results. For the navigation, the memory 254 may comprise the EMF map 290, and the floor plan 292 of the building 100 and of other buildings. The circuitry 260 may apply for example multi-hypothesis location estimator/tracker/filter, for example. The circuitry 260 may adjust the acquired EMF results on the basis of the determined 3D orientation of the mobile device 200. The circuitry 260 may also perform indoor navigation on the basis of orientation invariant methods, such as on the basis of radio frequency signal strengths, such as signal strength of wireless local area network base station or Bluetooth base stations.

A motion determination circuitry 262 may be for determining motion of the mobile device 200 on the basis of acquired motion data 310. In case the calibration of the sensors (magnetometer 220 and/or the motion sensor 222) is performed in the apparatus 250 (e.g. in the database entity), the apparatus 250 may further comprise a calibration & correction circuitry 264 for performing the proposed calibration process for the magnetometer 220 and/or for the motion sensor 222, for example.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus for determining a bias of a sensor, comprising:
at least one processor and at least one memory including a computer program code, wherein the at least one memory and the computer program code are configured, with the at least one processor, to cause the apparatus to perform operations comprising:
acquiring results of a set of Earth's magnetic field, EMF, measurements, wherein each EMF measurement is performed by a magnetometer comprised in a mobile device and indicates a measured EMF value with respect to the orientation of the mobile device at a measurement time;
acquiring motion data indicating the angular rotation that the mobile device experienced during each of a plurality of EMF measurement pairs, wherein each EMF measurement pair indicates a measured first and a second EMF value and the motion data is measured by at least one motion sensor comprised in the mobile device;
determining a bias estimate of the magnetometer on the basis of the plurality of EMF measurement pairs and the corresponding motion data by finding the bias estimate that minimizes distances between the measured second EMF values and the measured first EMF values rotated about the bias estimate by the corresponding angular rotations; and
determining a correction factor corresponding to the bias estimate and applying the correction factor to the magnetometer readings.

2. The apparatus of claim 1, wherein the minimization is based on least squares minimization algorithm and the distances are squared distances.

3. The apparatus of claim 1, wherein the minimization is based on finding the bias estimate by using a Kalman filter algorithm.

4. The apparatus of claim 1, wherein the at least one memory and the computer program code are configured, with the at least one processor, to cause the apparatus further to perform, for each predetermined test bias value, operations comprising:
determining bias-rotated second EMF value on the basis of the motion data, the measured first EMF value, and the test bias value;
determining a value of loss function based on distances between the bias-rotated second EMF value and the measured second EMF value over the plurality of EMF measurement pairs;
determining which of the test bias values provides a minimum value for the loss function; and
selecting that test bias value as the bias estimate of the magnetometer.

5. The apparatus of claim 1, wherein the at least one memory and the computer program code are configured, with the at least one processor, to cause the apparatus further to perform operations comprising:
determining at least one property of the EMF measurement pair;
comparing the at least one property with a predetermined at least one weighting threshold;
determining a weight factor for this EMF measurement pair on the basis of the comparison result; and
applying the weight factor in weighting the relevance of this EMF measurement pair for the determination of the bias estimate.

6. The apparatus of claim 1, wherein the at least one memory and the computer program code are configured, with the at least one processor, to cause the apparatus further to perform operations comprising:
determining, on the basis of at least one property of the EMF measurement pair, whether the corresponding EMF measurement pair is a valid or an invalid EMF measurement pair; and
upon detecting that the EMF measurement pair is valid, deciding to apply the EMF measurement pair in the determination of the bias; and
upon detecting that the EMF measurement pair is invalid, deciding not to apply the EMF measurement pair in the determination of the bias.

7. The apparatus of claim 5, wherein the at least one property comprises at least one of the following: angular velocity determined on the basis of the motion data, angular acceleration determined on the basis of the motion data, amount of rotation determined on the basis of the motion data, time duration between the first and the second EMF measurement, difference between the first and the second EMF measurement.

8. The apparatus of claim 1, wherein the at least one memory and the computer program code are configured, with the at least one processor, to cause the apparatus further to perform operations comprising:
determining a reliability metric of the current bias estimate for each direction of a three-dimensional space, wherein the reliability metric is based on the motion data;
upon detecting, on the basis of the reliability metric, that the reliability of the bias in at least one direction does not exceed a predetermined reliability level, deciding to continue the bias determination process; and
upon detecting, on the basis of the reliability metric, that the reliability in each direction exceed the predetermined reliability level, deciding to terminate the bias determination process.

9. The apparatus of claim 1, wherein the apparatus further comprises at least one filter, and the at least one memory and the computer program code are configured, with the at least one processor, to cause the apparatus further to perform operations comprising:
filtering the magnetometer readings prior to using the magnetometer readings in the determination of the bias estimate; and
filtering the motion sensor readings prior to using the motion data in the determination of the bias estimate.

10. The apparatus of claim 1, wherein the mobile device in an unknown location and in an unknown three-dimensional orientation.

11. The apparatus of claim 1, wherein the at least one memory and the computer program code are configured, with the at least one processor, to cause the apparatus further to perform operations comprising:
estimating the second EMF value of a given EMF measurement pair on the basis of the angular rotation measured by the at least one motion sensor and the determined bias estimate of the magnetometer; and
determining a correction factor for the at least one motion sensor of the mobile device on the basis of the estimated second EMF value and the second measured EMF value of the given EMF measurement pair.

12. The apparatus of claim 1, wherein the at least one memory and the computer program code are configured, with the at least one processor, to cause the apparatus further to perform operations comprising:
iteratively determining the correction factors for the magnetometer and for the motion sensor such that:
each time a correction factor for the magnetometer is under determination, motion data corrected by the correction factor of the motion sensor is used, and
each time a correction factor for the motion sensor is under determination, magnetometer readings corrected by the correction factor of the magnetometer are used.

13. The apparatus of claim 1, wherein the at least one memory and the computer program code are configured, with the at least one processor, to cause the apparatus further to perform operations comprising:
upon detecting that the correction factors of the magnetometer and of the motion sensor converge on the basis of a predetermined convergence criterion, deciding that the corrected readings of the magnetometer and of the motion sensor are reliable.

14. The apparatus of claim 1, wherein the apparatus is comprised in the mobile device and the apparatus further comprises:
the magnetometer configured to perform measurements of the EMF; and
the at least one motion sensor configured to measure the angular rotation of the apparatus.

15. A method for determining a bias of a sensor, comprising:
acquiring results of a set of Earth's magnetic field, EMF, measurements, wherein each EMF measurement is performed by a magnetometer comprised in a mobile device and indicates a measured EMF value with respect to the orientation of the mobile device at a measurement time;
acquiring motion data indicating the angular rotation that the mobile device experienced during each of a plurality of EMF measurement pairs, wherein each EMF measurement pair indicates a measured first and a second EMF value and the motion data is measured by at least one motion sensor comprised in the mobile device;
determining a bias estimate of the magnetometer on the basis of the plurality of EMF measurement pairs and the corresponding motion data by finding the bias estimate that minimizes distances between the measured second EMF values and the measured first EMF values rotated about the bias estimate by the corresponding angular rotations; and
determining a correction factor corresponding to the bias estimate and applying the correction factor to the magnetometer readings.

16. A computer program product embodied on a distribution medium readable by a computer and comprising program instructions which, when loaded into an apparatus, execute the method comprising steps of:
acquiring results of a set of Earth's magnetic field, EMF, measurements, wherein each EMF measurement is performed by a magnetometer comprised in a mobile device and indicates a measured EMF value with respect to the orientation of the mobile device at a measurement time;
acquiring motion data indicating the angular rotation that the mobile device experienced during each of a plurality of EMF measurement pairs, wherein each EMF measurement pair indicates a measured first and a second EMF value and the motion data is measured by at least one motion sensor comprised in the mobile device;
determining a bias estimate of the magnetometer on the basis of the plurality of EMF measurement pairs and the corresponding motion data by finding the bias estimate that minimizes distances between the measured second EMF values and the measured first EMF values rotated about the bias estimate by the corresponding angular rotations; and
determining a correction factor corresponding to the bias estimate and applying the correction factor to the magnetometer readings.
